(19) United States
(12) Patent Application Publication
(10) Pub. No.: US 2014/0074355 A1
(43) Pub. Date: Mar. 13, 2014

(54) HYBRID STEERING SYSTEM AND METHOD FOR CONTROLLING THE SAME

(71) Applicant: HYUNDAI MOTOR COMPANY, Seoul (KR)

(72) Inventors: Jong Min KIM, Gwangmyeong-si (KR); Soo Bo Park, Hwaseong-si (KR)

(73) Assignee: Hyundai Motor Company, Seoul (KR)

(21) Appl. No.: 13/708,468

(22) Filed: Dec. 7, 2012

(30) Foreign Application Priority Data
Sep. 10, 2012 (KR) 10-2012-0099923

(51) Int. Cl. B62D 6/02

(52) U.S. Cl. CPC B62D 6/02
USPC 701/41

(57) ABSTRACT

A hybrid steering system and a method for controlling the same. A motor driving power steering (MDPS) module at the rear end of a steering wheel includes a first torsion bar connected to a steering wheel shaft, a first torque sensor for measuring the torque of the first torsion bar, and an MDPS motor for applying the torque to the steering wheel shaft. An electro-hydraulic power steering (EHPS) module at the rear end of the MDPS module includes a second torsion bar connected to the steering wheel shaft and a hydraulic mechanism for applying hydraulic steering power. A control unit controls both the torque of the MDPS motor and the steering power of the hydraulic mechanism depending on the speed or steering angle of a vehicle so that both powers from the MDPS motor and the hydraulic mechanism can be applied to the steering wheel shaft.

### CROSS-REFERENCE TO RELATED APPLICATION

The present application claims priority of Korean Patent Application Number 10-2012-0099923 filed Sep. 10, 2012, the entire contents of which application is incorporated herein for all purposes by this reference.

### BACKGROUND OF INVENTION

1. Field of Invention

The present invention relates, in general, to a hybrid steering system and a method for controlling the same in which motor driving power steering (MDPS) and electro-hydraulic power steering (EHPS) are combined.

2. Description of Related Art

In general, a steering system requires a hydraulic pump since it uses hydraulic pressure as auxiliary steering power. However, since the hydraulic pump is actuated by the engine, the driving power of the engine is necessarily reduced.

Such a loss in the driving power of the engine results in a loss in fuel efficiency.

Therefore, it is possible to improve the fuel efficiency by as much as a decrease in the amount of the driving power of the engine that would otherwise be lost by the steering system.

As an example for improving fuel efficiency, a hydraulic steering system is provided with a hydraulic pump which is actuated by the engine. This hydraulic steering system can reduce a loss in the driving power of the engine by decreasing the line resistance of a hose or decreasing the flow rate of the pump while idling.

However, such an example for improving the fuel efficiency using the hydraulic steering system is not effective, since the hydraulic pump is actuated by the engine.

Therefore, it is preferable that the hydraulic pump which is actuated by the engine be omitted so that the steering system can obtain high effect of improving the fuel efficiency. Examples for such a steering system may include motor driven power steering (MDPS) in which an electric motor which does not need hydraulic pressure is used or electro-hydraulic power steering (EHPS) in which an electric pump which is actuated by a motor rather than by the driving power of the engine is used.

Therefore, the MDPS or EHPS can be used as a steering system of a hybrid vehicle in which an improvement in fuel efficiency is essentially required.

The improved fuel efficiency is a factor that must be pursued not only for motorcars for riding but also for commercial vehicles. In this circumstance, the ability of commercial vehicles to improve the fuel efficiency can be greatly increased when the hydraulic pump which uses the driving power of the engine can be omitted and the MDPS or EHPS can be used as the steering system.

However, the MDPS system and the EHPS system are inappropriate for the steering system for commercial vehicles such as a truck or a bus, since they are designed so as to be suitable for motorcars for riding.

The main reason that the steering system for commercial vehicles is not replaced by the MDPS system or the EHPS system is attributable to the steering capacity of the steering system. For example, steering capacity of about 13 KN is sufficient for motorcars for riding, whereas commercial vehicles require a steering capacity ranging from about 50 KN to 190 KN.

This consequently makes it difficult to use the MDPS system or the EHPS system, which is highly effective for the improvement of the fuel efficiency, in commercial vehicles.

Therefore, a new concept of a steering system that can improve the fuel efficiency while satisfying the steering capacity is required for commercial vehicles, and a control logic which guarantees steering stability for such a system is also required.

As a related art in which both the MDPS and the EHPS are used, Korean Patent No. 1071563, titled “STEERING SYSTEM FOR VEHICLE COMBINING MDPS AND EHPS,” may be referred to. This patent relates to the steering system in which the MDPS and the EHPS are combined. More specifically, this patent relates to the steering system in which steering is carried out by combining the MDPS and the EHPS so that the MDPS and the EHPS can perform complementary functions and auxiliary steering power can be provided at an emergency steering failure in order to guarantee stability. For this, the steering system includes an MDPS which assists steering power using the torque of a main motor and an EHPS which assists the steering power using hydraulic pressure that is generated by actuation of a hydraulic pump. The MDPS is used as a main steering device, and the EHPS is used as an auxiliary steering device in order to assist insufficient steering power during emergency malfunctioning of the motor or in heavy duty vehicles.

However, this structure relates to a patent involving a system which has a rack-and-pinion configuration, but in practice, cannot be applied to heavy duty commercial vehicles because of insufficient capacity. In addition, this structure only relates to a concept of using the MDPS as the main steering device and applying the EHPS as the auxiliary steering device which acts when the main steering device malfunctions or compensates for an insufficient amount of steering power, but there is no concept related to the control logic. Consequently, an additional configuration such as the control logic is still required in order to apply both the MDPS and EHPS as main steering devices and to improve performance for that purpose.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made keeping in mind the above problems occurring in the related art. Various aspects of the present invention provide for a hybrid steering system and a method for controlling the same in which both motor driving power steering (MDPS) and electro-hydraulic power steering (EHPS) can be used as main steering systems at the same time.

Various aspects of the present invention provide for a hybrid steering system that includes: an MDPS module disposed at a rear end of a steering wheel, an EHPS module disposed at a rear end of the MDPS module, and a control unit. The MDPS module includes a first torsion bar which is connected to a steering wheel shaft, a first torque sensor which measures the torque of the first torsion bar, and an MDPS motor which applies the torque to the steering wheel shaft. The EHPS module includes a second torsion bar which is connected to the steering wheel shaft and a hydraulic mechanism which applies steering power using hydraulic pressure depending on the torsion of the second torsion bar. The control unit controls both the torque of the MDPS motor and the steering power of the hydraulic mechanism depending on the speed or the steering angle of a vehicle so that both powers from the MDPS motor and the hydraulic mechanism can be applied to the steering wheel shaft.

The control unit may improve steering ability by increasing the steering power that is applied by the hydraulic mechanism when the vehicle runs at a low speed and improve driving stability by decreasing the steering power that is applied by the hydraulic mechanism when the vehicle runs at a high speed.

When the first torsion bar has greater rigidity than the second torsion bar, the control unit may maximize the steering power of the hydraulic mechanism when the vehicle runs at a low speed, and may control both the powers from the MDPS motor and the hydraulic mechanism when the vehicle runs at a high speed.

When the first torsion bar has smaller rigidity than the second torsion bar, the control unit may increase the steering power that is generated by the hydraulic mechanism while decreasing the torque by the MDPS motor when the vehicle runs at a low speed, and may decrease the steering power that is generated by the hydraulic mechanism while increasing the torque by the MDPS motor when the vehicle runs at a high speed.

Various aspects of the present invention provide for a method of controlling a hybrid steering system that includes: a speed-measuring step of measuring a speed of a vehicle; a vehicle speed-determining step of determining whether the vehicle runs at a low speed or a high speed by comparing the speed of the vehicle with a reference speed; a low-speed control step of improving steering ability by increasing steering power from the hydraulic mechanism when the vehicle runs at the low speed; and a high-speed control step of improving driving stability by decreasing the steering power that is generated.

Various aspects of the present invention provide for a method of controlling a hybrid steering system that includes: a speed-measuring step of measuring the speed of a vehicle; a vehicle speed-determining step of determining whether the vehicle runs at a low or high speed by comparing the speed of the vehicle with a reference speed; a low-speed control step of increasing the steering power that is applied by a hydraulic mechanism to the maximum and controlling the torque of an MDPS motor depending on a torque that is measured by a first torque sensor when the vehicle runs at the low speed; a first high-speed control step of decreasing the torque that is applied by the MDPS motor and controlling the steering power of the hydraulic mechanism depending on a torque that is measured by a second torque sensor when the vehicle runs at the high speed and steering is on-center; and a second high-speed control step of decreasing the steering power that is applied by the hydraulic mechanism and controlling the torque of the MDPS motor depending on the torque that is measured by the first torque sensor when the vehicle runs at the high speed and the steering is off-center.

Various aspects of the present invention provide for a method of controlling a hybrid steering system that includes: a speed-measuring step of measuring the speed of a vehicle; a vehicle speed-determining step of determining whether the vehicle runs at a low or high speed by comparing the speed of the vehicle with a reference speed; a low-speed control step of increasing steering power that is applied by a hydraulic mechanism and decreasing a torque that is applied by the MDPS motor when the vehicle runs at the low speed; and a high-speed control step of decreasing the steering power that is applied by the hydraulic mechanism and increasing the torque that is applied by the MDPS motor when the vehicle runs at the high speed.

According to the hybrid steering system and the method for controlling the same which are configured as described above, it is possible to improve fuel efficiency for 3 to 4% by providing a vehicle with a novel hybrid steering system. Since a plurality of torsion bars are applied, rebounding force from the road is accurately detected and thus steering ability is improved.

Furthermore, it is easy to precisely control on-center feeling, prevent the sense of difference in steering, and control the system depending on the respective speeds of a vehicle. It is also possible to set the EHPS to take charge of most of the steering of the vehicle or the MDPS and the EHPS to share the steering of the vehicle as required, thereby improving the endurance of components.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configuration view of an exemplary hybrid steering system according to the invention.

FIG. 2 is a flowchart illustrating an exemplary method of controlling the hybrid steering system shown in FIG. 1.

FIG. 3 is a flowchart illustrating another exemplary method of controlling the hybrid steering system shown in FIG. 1.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

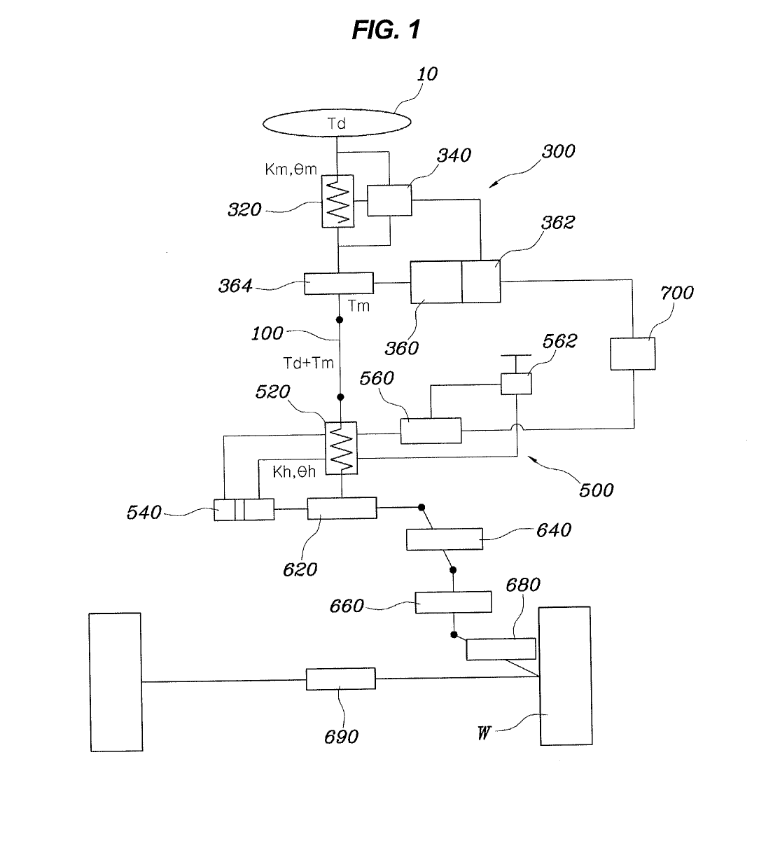

FIG. 1 is a configuration view of the hybrid steering system according to various embodiments of the invention. The hybrid steering system various embodiments includes a motor driving power steering (MDPS) module 300 disposed at the rear end of a steering wheel 10, an electro-hydraulic power steering (EHPS) module 500 disposed at the rear end of the MDPS module 300 and a control unit 700. The MDPS module 300 includes a first torsion bar 320 which is connected to a steering wheel shaft 100, a first torque sensor 340 which measures the torque of the first torsion bar 320, and an MDPS motor 360 which applies the torque to the steering wheel shaft 100. The EHPS module 500 includes a second torsion bar 520 which is connected to the steering wheel shaft 100 and a hydraulic mechanism 560 which applies steering power using hydraulic pressure depending on the torsion of the second torsion bar 520. The control unit 700 controls both the torque of the MDPS motor 360 and the steering power of the hydraulic mechanism 560 depending on the speed or the steering angle of the vehicle so that both powers from the MDPS motor and the hydraulic mechanism can be applied to the steering wheel shaft 100.

The hybrid steering system of various embodiments is characterized by providing a suitable sensation of steering depending on various situations by using the MDPS and the EHPS at the same time and cooperatively controlling the MDPS and the EHPS. For this, the MDPS and the EHPS are configured such that they are connected in series to the steering wheel shaft 100.

First, the MDPS module 300 which includes the first torsion bar 320 connected to the steering wheel shaft 100, the first torque sensor 304 for measuring the torque of the first torsion bar 320, and the MDPS motor 360 for applying the torque to the steering wheel shaft 100 is disposed at the rear end of the steering wheel 10.

Steering torque that a driver applies using the steering wheel 10 will be referred to as Td. The torque Td by the driver is applied to the first torsion bar 320 of the MDPS module 300. The first torque sensor 340 then measures the torque Td. In addition, a torque that is generated by the MDPS motor 360 is added to the steering wheel shaft 100, so that torque that is resultantly applied becomes Td+Tm, where Td is the torque by the driver and Tm is the torque of the motor.

The torque Td+Tm is then applied to the second torsion bar 520 of the EHPS module 500, and a valve is opened as the second torsion bar 520a is twisted. Consequently, hydraulic pressure is supplied by a motor pump, and rack force is supplied by a cylinder device 540. The steering force that the hydraulic mechanism 560, i.e. the motor pump, applies refers to the power of the motor that is intended to generate the rack force.

In addition, a second torque sensor may be disposed in the valve side in order to measure a helix angle, which can be used for precise control over the MDPS or EHPS. More specifically, this configuration also includes an MDPS motor electronic control unit (ECU) and a decelerator 364 in the case of the MDPS motor. In the case of the hydraulic mechanism, a reservoir 562, a cylinder device 540 and a ball nut 620 are provided. The final power that is generated by the combination of the MDPS and the EHPS is transferred to individual wheels W via a pitman arm 640, a drag link 660, a spindle arm 680 and a tie rod 690.

The control unit 700 controls both the torque of the MDPS motor 360 and the steering power of the hydraulic mechanism 560 so that both the powers from the MDPS motor and the hydraulic mechanism can be applied to the steering wheel shaft 100.

Specifically, the control unit 700 improves the steering ability by increasing the steering power that is applied by the hydraulic mechanism 560 when a vehicle runs at a low speed and improves driving stability by decreasing the steering power that is applied by the hydraulic mechanism 560 when the vehicle runs at a high speed. Thus, when the vehicle runs at the low speed, the influence by the hydraulic mechanism 560 is decreased by increasing the steering power of the hydraulic mechanism 560, so that the control by the MDPS motor 360 can be more predominant. Accordingly, the driver can obtain a smooth and accurate sense of steering while expending a lesser effort.

In addition, when the vehicle runs at the low speed, the control unit 700 controls the sense of steering to be generally heavy by decreasing the steering power that is applied by the hydraulic mechanism 560, so that the control by the hydraulic mechanism 560 is prevalent at an equivalent ratio to that by the MDPS motor 360, thereby providing a smooth sense of steering.

When the rigidity of the first torsion bar 320 is greater than the rigidity of the second torsion bar 520, the control unit 700 maximizes the steering power of the hydraulic mechanism 560 when the vehicle runs at the low speed but controls both the powers from the MDPS motor 360 and the hydraulic mechanism 560 when the vehicle runs at the high speed. When the rigidity of the first torsion bar 320 is designed to be greater than the rigidity of the second torsion bar 520, the control unit 700 increases the steering power that is generated by the hydraulic mechanism 560 to the maximum when the vehicle runs at the low speed in order to remove the influence of the hydraulic pressure but controls both the powers of the MDPS motor 360 and the hydraulic mechanism 560 when the vehicle runs at the high speed.

In contrast, when the rigidity of the first torsion bar 320 is smaller than the rigidity of the second torsion bar 520, the control unit 700 increases the steering power that is generated by the hydraulic mechanism 560 while decreasing the torque by the MDPS motor 360 when the vehicle runs at the low speed, but decreases the steering power that is generated by the hydraulic mechanism while increasing the torque by the MDPS motor 360 when the vehicle runs at the high speed. Consequently, it is possible to control both the hydraulic pressure and the MDPS motor at the same time.

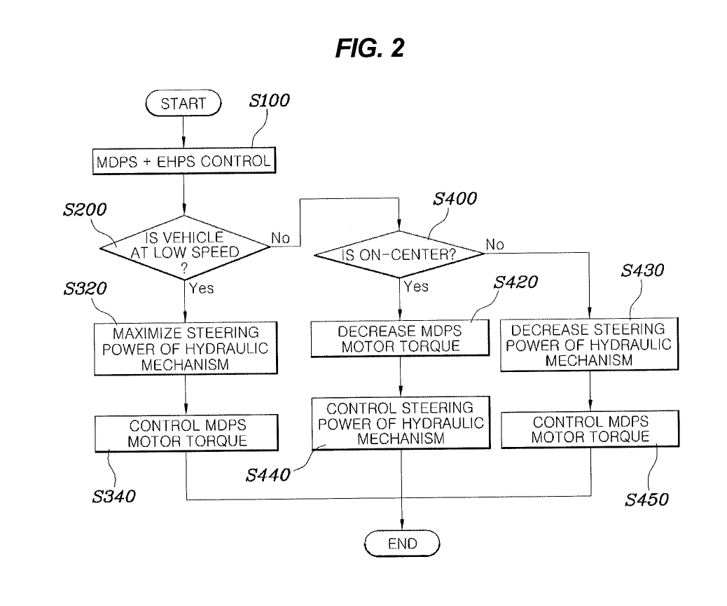

FIG. 2 is a flowchart illustrating a method of controlling the hybrid steering system shown in FIG. 1. The method of controlling the hybrid steering system of various embodiments includes a speed-measuring step of measuring the speed of a vehicle, a vehicle speed-determining step S200 of determining whether the vehicle runs at a low or high speed by comparing the speed of the vehicle with a reference speed, a low-speed control step of improving steering ability by increasing steering power from the hydraulic mechanism when the vehicle runs at the low speed, and a high-speed control step of improving driving stability by decreasing the steering power that is generated by the hydraulic mechanism when the vehicle runs at the high speed.

More specifically, FIG. 2 shows the case in which the rigidity of the first torsion bar 320 is greater than the rigidity of the second torsion bar 520. In this case, first, the method of controlling the hybrid steering system performs simultaneous control using the MDPS and the EHPS at S100. The method also includes the speed-measuring step of measuring the speed of the vehicle, the vehicle speed-determining step S200 of determining whether the vehicle runs at the low or high speed by comparing the speed of the vehicle with the reference speed, low-speed control steps S320 and S340 of increasing the steering power that is applied by the hydraulic mechanism to the maximum and controlling the torque of the MDPS motor depending on a torque that is measured by the first torque sensor when the vehicle runs at the low speed, an on-center determining step S400 of determining whether steering is on-center, first high-speed control steps S420 and S440 of decreasing the torque that is applied by the MDPS motor and controlling the steering power of the hydraulic mechanism depending on the torque that is measured by the second torque sensor when the vehicle runs at the high speed and the steering is on-center, and second high-speed control steps S430 and S450 of decreasing the steering power that is applied by the hydraulic mechanism and controlling the torque of the MDPS motor depending on the torque that is measured by the first torque sensor when the vehicle runs at the high speed and the steering is off-center.

When the rigidity of the first torsion bar is further greater, the influence by the hydraulic mechanism is decreased by raising the steering power of the hydraulic mechanism to the maximum at the low speed. Consequently, the control by the MDPS motor is prevalent so that the control by the MDPS becomes predominant. When the steering is on-center at the high speed, it is required to properly maintain straight-line stability. The influence of the MDPS is reduced by decreasing the torque that is applied by the MDPS motor and the steering power of the hydraulic mechanism is controlled depending on a torque that is measured by the second torque sensor. In addition, in the case of being off center, the influence by the EHPS is reduced by decreasing the steering power that is applied by the hydraulic mechanism and the torque of the MDPS motor is controlled depending on the torque that is measured by the first torque in order to raise accuracy and convenience in the steering for the purpose of cornering stability.

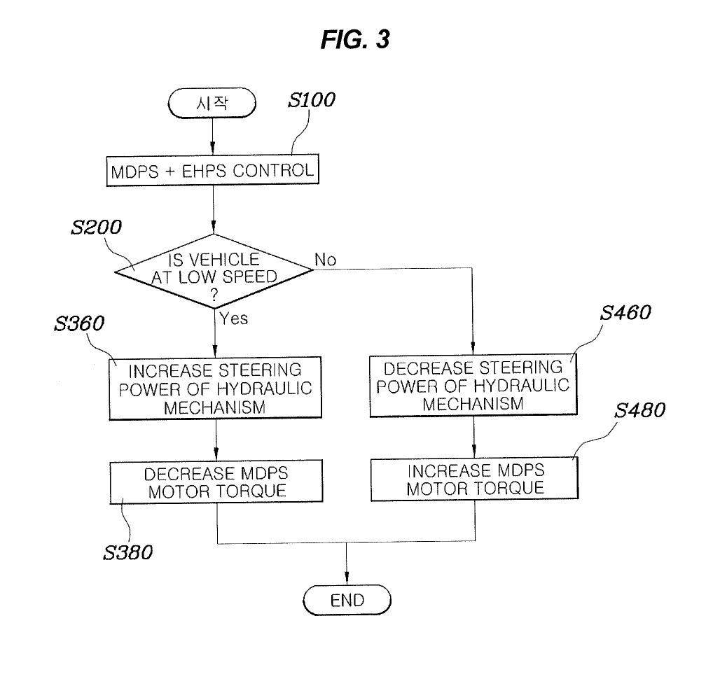

FIG. 3 is a flowchart illustrating another method of controlling the hybrid steering system shown in FIG. 2. This is the case in which the rigidity of the first torsion bar 320 is smaller than the rigidity of the second torsion bar 520. In this case, the method of controlling the hybrid steering system includes a speed-measuring step of measuring the speed of a vehicle, a vehicle speed-determining step S200 of determining whether the vehicle runs at a low or high speed by comparing the speed of the vehicle with a reference speed, low-speed control steps S360 and S380 of increasing the steering power that is applied by the hydraulic mechanism and decreasing the torque that is applied by the MDPS motor when the vehicle runs at the low speed, and high-speed control steps S460 and S480 of decreasing the steering power that is applied by the hydraulic mechanism and increasing the torque that is applied by the MDPS motor when the vehicle runs at the high speed.

In this case, at the low speed, the EHPS which is heavy is compensated so as to be smoother by increasing the steering power that is applied by the hydraulic mechanism, but the MDPS which is light is compensated so as to be heavier by decreasing the torque that is applied by the MDPS motor, so a suitable sense of steering can be produced.

In contrast, at the high speed, the heaviness of the EHPS is maintained to a certain degree by decreasing the steering power that is applied by the hydraulic mechanism and the MDPS is set to be heavier for the EHPS which has been made heavier by increasing the torque that is applied by the MDPS motor, so that an excessive amount of force is not applied to the steering.

According to the above-described control methods which are separate from each other, the driver can properly feel the convenience and stability in the steering depending on occasion.

For convenience in explanation and accurate definition in the appended claims, the terms rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. A hybrid steering system of a vehicle comprising:
a motor driving power steering (MDPS) module disposed at a rear end of a steering wheel, wherein the MDPS module comprises a first torsion bar connected to a steering wheel shaft, a first torque sensor which measures a torque of the first torsion bar, and an MDPS motor which applies the torque to the steering wheel shaft;
an electro-hydraulic power steering (EHPS) module disposed at a rear end of the MDPS module, wherein the EHPS module comprises a second torsion bar connected to the steering wheel shaft and a hydraulic mechanism which applies steering power using hydraulic pressure depending on the torsion of the second torsion bar; and
a control unit, wherein the control unit controls both the torque of the MDPS motor and the steering power of the hydraulic mechanism depending on a speed or a steering angle of the vehicle so that both powers from the MDPS motor and the hydraulic mechanism can be applied to the steering wheel shaft.

2. The hybrid steering system of claim 1, wherein the control unit improves steering ability by increasing the steering power that is applied by the hydraulic mechanism when the vehicle runs at a low speed and improves driving stability by decreasing the steering power that is applied by the hydraulic mechanism when the vehicle runs at a high speed.

3. The hybrid steering system of claim 1, wherein, when the first torsion bar has greater rigidity than the second torsion bar, the control unit maximizes the steering power of the hydraulic mechanism when the vehicle runs at a low speed but controls both the powers from the MDPS motor and the hydraulic mechanism when the vehicle runs at a high speed.

4. The hybrid steering system of claim 1, wherein, when the first torsion bar has smaller rigidity than the second torsion bar, the control unit increases the steering power that is generated by the hydraulic mechanism while decreasing the torque by the MDPS motor when the vehicle runs at a low speed, but decreases the steering power that is generated by the hydraulic mechanism while increasing the torque by the MDPS motor when the vehicle runs at a high speed.

5. A method of controlling a hybrid steering system of a vehicle, comprising:
a speed-measuring step of measuring a speed of the vehicle;
a vehicle speed-determining step of determining whether the vehicle runs at a low speed or a high speed by comparing a speed of the vehicle with a reference speed;
a low-speed control step of improving steering ability by increasing steering power from the hydraulic mechanism when the vehicle runs at the low speed; and
a high-speed control step of improving driving stability by decreasing the steering power that is generated by the hydraulic mechanism when the vehicle runs at the high speed.

6. A method of controlling a hybrid steering system of a vehicle, comprising:
a speed-measuring step of measuring a speed of the vehicle;
a vehicle speed-determining step of determining whether the vehicle runs at a low speed or a high speed by comparing a speed of the vehicle with a reference speed;
a low-speed control step of increasing steering power that is applied by a hydraulic mechanism to a maximum and controlling a torque of a motor driving power steering (MDPS) motor depending on a torque that is measured by a first torque sensor when the vehicle runs at the low speed;
a first high-speed control step of decreasing the torque that is applied by the MDPS motor and controlling the steering power of the hydraulic mechanism depending on a torque that is measured by a second torque sensor when the vehicle runs at the high speed and steering is on-center; and
a second high-speed control step of decreasing the steering power that is applied by the hydraulic mechanism and controlling the torque of the MDPS motor depending on the torque that is measured by the first torque sensor when the vehicle runs at the high speed and the steering is off-center.

7. The method of controlling a hybrid steering system of a vehicle of claim 5, comprising:
wherein the low-speed control step includes decreasing a torque that is applied by a motor driving power steering (MDPS) motor when the vehicle runs at the low speed; and
wherein the high-speed control step includes increasing the torque that is applied by the MDPS motor when the vehicle runs at the high speed.
